(19) United States
(12) Patent Application Publication
(10) Pub. No.: US 2007/0219786 A1
(43) Pub. Date: Sep. 20, 2007

(54) Method for providing external user automatic speech recognition dictation recording and playback

(76) Inventors: Emad S. Isaac, Woodridge, IL (US); Daniel S. Rokusek, Long Grove, IL (US); Edward Srenger, Schaumburg, IL (US)

Correspondence Address: MOTOROLA, INC., 1303 EAST ALGONQUIN ROAD, IL01/3RD, SCHAUMBURG, IL, 60196, US

(21) Appl. No.: 11/375,734

(22) Filed: Mar. 15, 2006

(51) Int. Cl. G10L 19/00

(52) U.S. Cl. 704/201

(57) ABSTRACT

A method of providing information storage by means of Automatic Speech Recognition through a communication device of a vehicle comprises establishing a voice communication between an external source and a user of the vehicle, receiving information from the external source, processing the received information using an Automatic Speech Recognition unit in the vehicle and storing the recognized speech in textual form for future retrieval or use.

### FIELD OF THE INVENTION

The present embodiments relate, generally, to communication devices and, more particularly, to a method of providing an external user with automatic speech recognition dictation recording and playback.

### BACKGROUND OF THE INVENTION

Automatic Speech Recognition (ASR) typically uses a set of grammars or rules that control the user's range of options at any point within the voice controlled user interface. ASR systems utilize voice dialogs, and users interact with these voice dialogs through the oldest interface known to mankind: the voice. A user can invoke an action to be taken by a system through a vocal command. Thus, ASR systems can be used for dictation or to control computerized devices using spoken commands.

Advances in speech-based technologies have provided computers with the capability to cost-effectively recognize and synthesize speech. Additionally, wireless communications have ascended to where the number of mobile phones will eclipse land-based phones, and the Internet has become a commonplace communication mechanism for businesses. The confluence of these technologies portends interesting opportunities for information exchanges.

Information exchange is a highly mobile activity. This mobility requirement constrains a user's ability to receive and provide information that can improve productivity, reduce costs, and improve overall information exchange process. Once a user ventures beyond their wired environment, their options to gain access to information resources diminish.

As telecommunication systems continue to expand and add new services, such systems are capable of providing useful information to users of communication devices. ASR systems are efficient tools that automated telecommunication services can utilize to provide information to users of communication devices that find themselves in eyes-busy/hands-busy situations.

Essentially, ASR may be applied to almost any voice activated application. ASR, however, needs to have the flexibility and performance to cater to a wide range of environments, such as in automotive vehicles.

During operations of an automotive vehicle, an operator, driver or user may seek specific information from an external or distant wireless caller. The vehicle user is typically in hand-busy and/or eye-busy situations. In these situations, communication devices may not provide the user with the flexibility to store or write down the information received from the external caller.

Accordingly, there is a need for addressing the problems noted above and others previously experienced.

### BRIEF DESCRIPTION OF THE DRAWINGS

Embodiments of the present invention are now described, by way of example only, with reference to the accompanying figures in which:

FIG. 1 is a block diagram of a telecommunications system;

FIG. 2 is a block diagram of a telematics communication unit for a vehicle;

FIG. 3 is a block diagram of an ASR unit for a vehicle;

FIG. 4 is a flow chart showing a method for recording information stated by an external caller in the ASR unit of the vehicle; and

FIG. 5 is a flow chart showing a method for playing back information stored in the ASR unit of the vehicle;

Illustrative and exemplary embodiments of the invention are described in further detail below with reference to and in conjunction with the figures.

### DETAILED DESCRIPTION OF THE INVENTION

The present invention is defined by the appended claims. This description summarizes some aspects of the present embodiments and should not be used to limit the claims.

While the present invention may be embodied in various forms, there is shown in the drawings and will hereinafter be described some exemplary and non-limiting embodiments, with the understanding that the present disclosure is to be considered an exemplification of the invention and is not intended to limit the invention to the specific embodiments illustrated.

In this application, the use of the disjunctive is intended to include the conjunctive. The use of definite or indefinite articles is not intended to indicate cardinality. In particular, a reference to “the” object or “a and an” object is intended to denote also one of a possible plurality of such objects.

A method for generating a transcription of a speech sample by means of an ASR system through a communication device of a vehicle includes establishing a voice communication between an external source and a user of the vehicle, receiving information from the external source, and using an ASR unit in the vehicle to interpret the speech samples received from either the external source or the user of the vehicle.

Another method for providing a voice recording and playback mechanism through a communication device of a vehicle includes establishing a voice communication between an external source and a user, receiving information from the external source, interpreting the received information using an ASR unit, generating a text transcription from an output of the ASR unit, and providing the text representation to a navigational system or inputting this text representation to a text-to-speech (TTS) system to provide an audio feedback to the user of the recognized utterances. Let us now refer to the figures that illustrate embodiments of the present invention in detail.

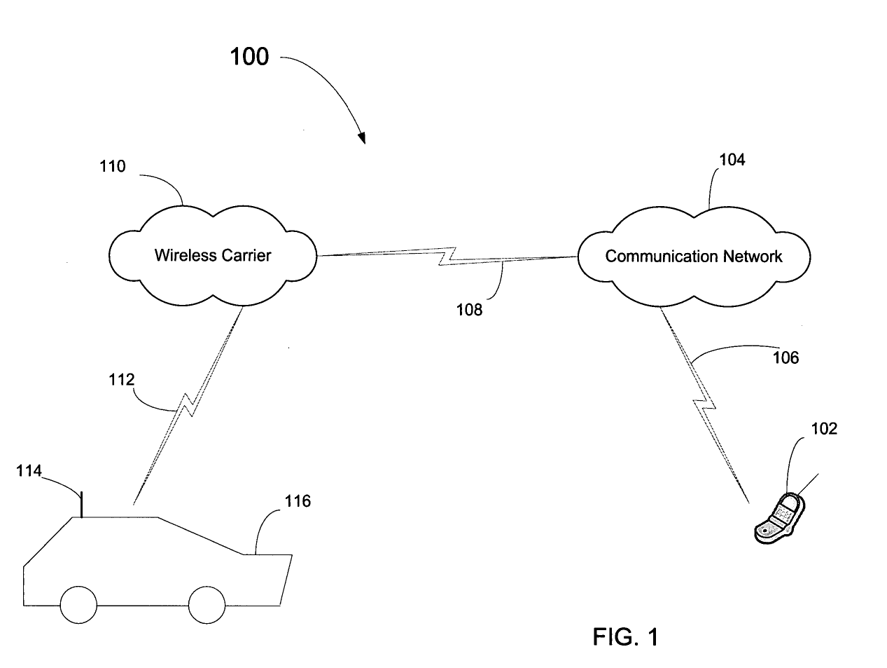

Turning first to FIG. 1, a system level diagram of a telecommunication system 100 is shown. As will be described in detail in reference to later figures, a number of elements of a telecommunication system 100 may employ the methods disclosed in the present application. In one exemplary embodiment, a telecommunication system 100 preferably comprises a communication device 102 which is adapted to communicate with a communication network 104 by way of a communication link 106. The communication device 102 may be a wireless communication device, such as a cellular telephone, a pager, a personal digital assistant (PDA) having wireless voice capability, or a conventional wire-line device, such as a conventional telephone or a computer connected to a wire line network. Similarly, the communication network 104 may be any type of communication network, such as a landline communication network or a wireless communication network, both of which are well known in the art. A communication link 108 enables communication between the communication network 104 and a wireless carrier 110. The communication link 108 could be any type of communication link for processing voice signals, such as any type of signaling protocol used in any conventional landline or wireless communication network.

A communication link 112 enables communication to a wireless communication device or system 114 of a vehicle 116. The wireless communication system 114 may be, for example, a telematics communication unit installed in a vehicle 116. Most current telematics communication units include a wireless communication device embedded within the vehicle for accessing the telematics service provider. For example, conventional telematics communication units may include a cellular telephone transceiver to enable communication between the vehicle and another communication device or a call center associated with telematics service for the vehicle. The vehicle 116 may have a handset coupled to the wireless communication system 114, and/or include hands-free functionality within the vehicle 116. Alternatively, a portable phone operated by the user could be physically or wirelessly coupled to the wireless communication system 114 of the telematics communication unit, enabling synchronization between the portable phone and the wireless communication device 114 of the vehicle 116. For ease of explanation, the following description and examples assumes the wireless communication system 114 is a telematics communication unit, however, the spirit and scope of the present invention is not limited to such.

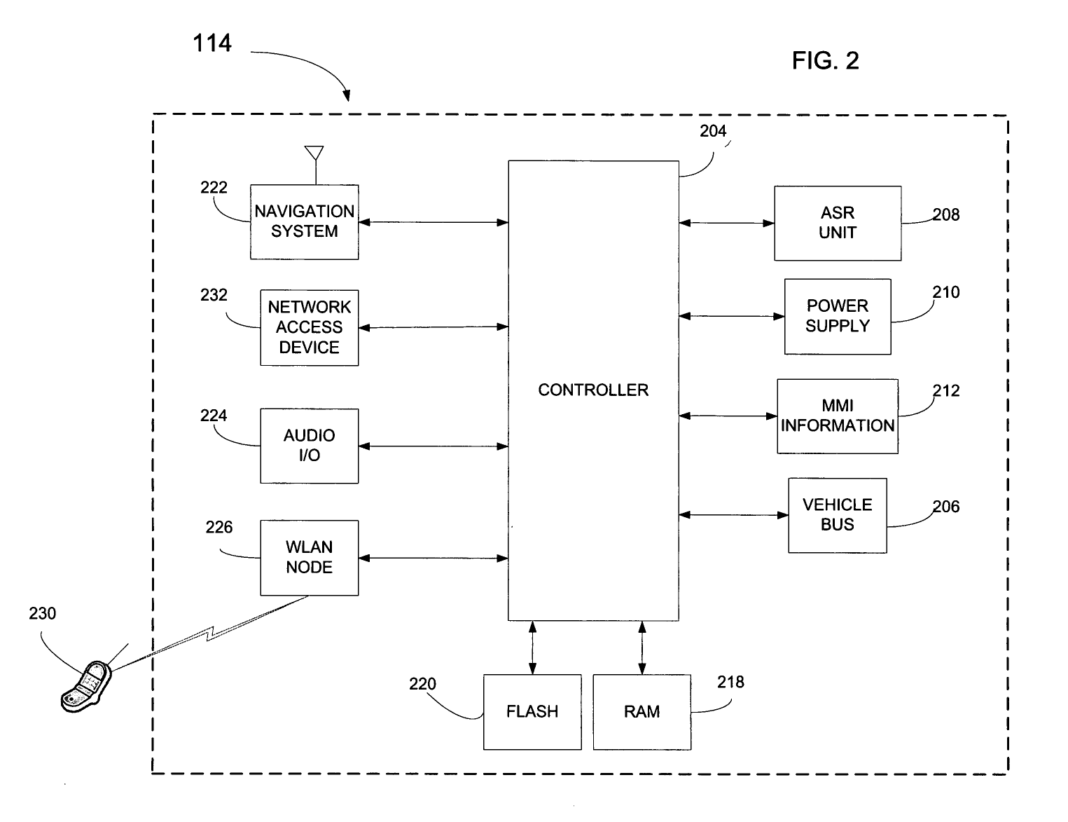

Turning now to FIG. 2, a block diagram of a telematics communication unit 114 which can be installed in the vehicle 116 according to the present invention is shown. The telematics communication unit 114 comprises a controller 204 having various input/output (I/O) ports for communicating with various components of the vehicle 116. For example, the controller 204 is coupled to a vehicle bus 206, an ASR unit 208, a power supply 210, and a man machine interface (MMI) 212 enabling a user interaction with the telematics communication unit 114. The connection to the vehicle bus 206 enables operations such as unlocking the door, sounding the horn, flashing the lights, etc. The controller 204 may be coupled to various memory elements, such as a random access memory (RAM) 218 or a flash memory 220. The controller 204 may also include a navigation system 222, which may comprise a global positioning system (GPS) unit 222 which provides the location of the vehicle, and/or a navigational unit which provides information useful in determining a course of the vehicle 116, as are well known in the art. This in-vehicle navigation system 222 may be coupled to or combined with the ASR unit 208 to process destination or directional input and offer point-to-point GPS guidance with spoken instructions.

The controller 204 can also be coupled to an audio I/O 224 which preferably includes a hands-free system for audio communication for a user of the vehicle 116 by way of the network access device 232 or the wireless communication device 230 (by way of wireless local area network (WLAN) node 226). The audio I/O 224 may be integrated with the vehicle speaker system (not shown). Thus, the controller 204 couples audio communication from the network access device 232 to the audio I/O 224. Similarly, the controller 204 couples audio from the wireless communication device 230 (by way of communication link 231 and WLAN node 226) to the audio I/O 224. Alternatively, a wired handset (not shown) may be coupled to the network access device 232.

The telematics communication unit 114 may also include a WLAN node 226 which is also coupled to the controller 204 and enables communication between a WLAN enabled device such as a wireless communication device 230 and the controller 204. According to one embodiment, the wireless communication device 230 may provide the wireless communication functionality of the telematics communications unit 114, thereby eliminating the need for the network access device 232. In other words, using a portable cellular telephone 230 to provide the functionality of the wireless communication device 230 for the telematics communication unit 114 eliminates the need for a separate cellular transceiver, such as the network access device 232, in the vehicle, thereby reducing cost of the telematics communication unit 114. A WLAN-enabled device (e.g., wireless communication device 230) may communicate with the WLAN-enabled controller 204 by any WLAN protocol, such as Bluetooth, IEEE 802.11, infrared direct access (IrDA), or any other WLAN application. Although the WLAN node 226 is described as a wireless local area network, such a communication interface may by any short range wireless link, such as a wireless audio link. The built-in Bluetooth capability may be used in conjunction with the ASR unit 208 to access personal cell-phone data and provide the user with hands-free, speech-enabled dialing.

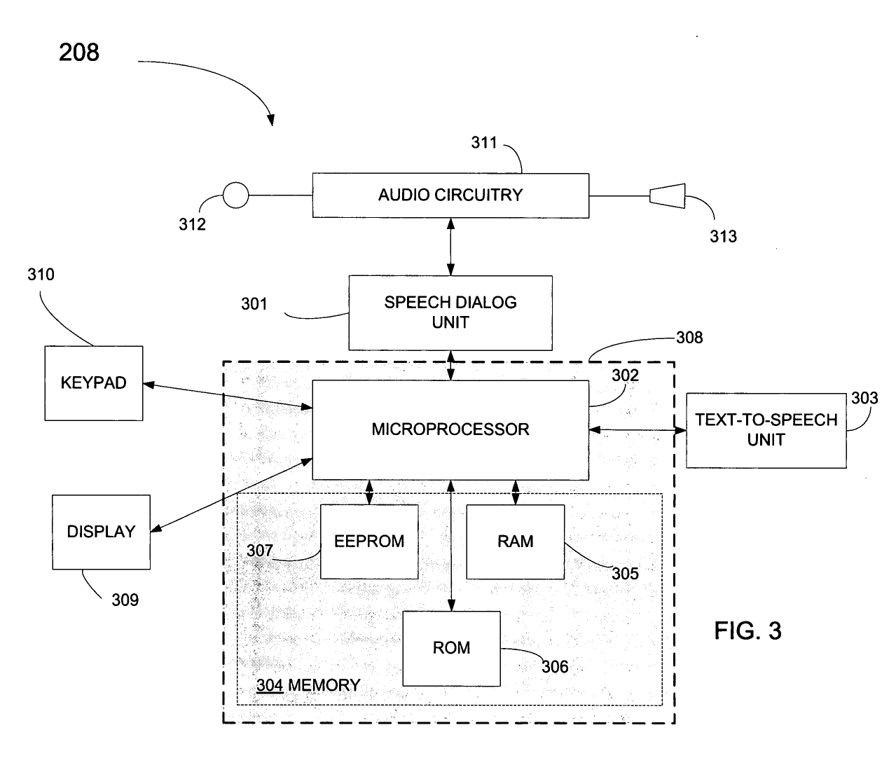

Turning now to FIG. 3, a block diagram of an example ASR unit 208 is shown. In one embodiment, a speech dialog unit 301, a microprocessor 302, and a TTS unit 303 may combine to gather spoken input from users, analyze them, and produce audio utterances from stored text. Microprocessor 302 uses memory 304 comprising at least one of a random access memory (RAM) 305, a read-only memory (ROM) 305, and an electrically erasable programmable ROM (EEPROM) 306. The microprocessor 302 and the memory 304 may be consolidated in one package 308 to perform functions for the ASR unit 208, such as writing to a display 309 and accepting spoken information and requests from a keypad 310. The speech dialog unit 301 may process audio transformed by audio circuitry 311 from a microphone unit 312 and to a speaker unit 313. The speaker unit 313 and/or the microphone unit 312 may be coupled to the audio I/O unit 224. Alternately, the speaker unit 313 and/or the microphone unit 312 may be integrated with the audio I/O unit 224.

The ASR unit 208, a speech-based interface, may be comprised of the speech dialog unit 301 (speech recognition sub-unit), TTS unit 303, and a keypad 310. As stated above, the speech dialog unit 301 is capable of recognizing utterances while the controller 204 is capable of recognizing information keyed on the keypad 310, such as that generated by pressing characters. The ASR unit 208, if triggered by the user, may monitor a discussion or a call in order to recognize various keywords, phrases or other utterances by either the external caller or the user at any point during the call. These keywords or phrases may act as triggers, and once identified by the ASR unit 208, may cause the ASR unit 208 to take a predetermined action based on the predetermined trigger encountered. Statements uttered by the user may include words and phrases such as “repeat,” “OK,” “next,” “record,” “stop,” “erase,” “rewind” “playback,” among others. The ASR unit 208 may be activated to process conversations between the external caller and the user at all points during the call, or only at selected conversation time points. The ASR unit 208 may be activated by a predetermined keyword or phrase, or by an operation of a mechanical switch. The speech data processed by the ASR unit 208 may either result in an action such as “Record” or “Playback”, or be selectively stored, once the recognized utterances have been verified either visually on a display 309 or through an audio feedback.

The ASR unit 208 may not need a lengthy ASR protocol and may respond to voice utterances that are not sensitive to the accent or dialect of the user or external caller. Moreover, ASR errors may be corrected by simply repeating the uttered words or phrases. The ASR unit 208 may be resistant to environmental, road and/or vehicular noise.

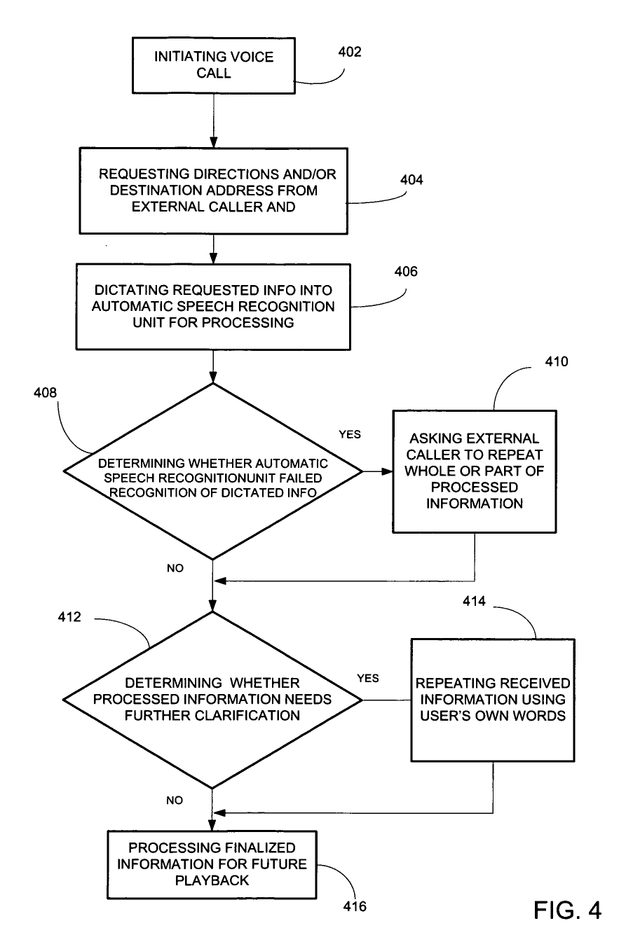

Turning now to FIG. 4, a flow chart shows a method for providing a monitoring feature delivered through the use of an ASR system during a voice call. The method may be implemented via the telematics communication unit 114. In one example embodiment, the telematics communication unit 114 is prompted to activate the ASR unit 208 when either the user or the external caller initiates a voice call, at step 402. Alternatively, the ASR unit 208 may be activated by either a mechanical switch or a conversation monitoring unit (not shown) which utilizes the ASR unit 208 to trigger on predetermined keywords as previously described. Apart from monitoring verbal conversations via the ASR unit 208, the telematics communication unit 114 may monitor introduction of information, such as keyed information by the near-end user.

At step 404, the user requests information regarding an address, a destination, or driving directions of a route or journey. As the vehicle user may be typically in a hand-busy and/or eye-busy situation, an external source, such as a person or a network based navigation or information retrieval system, may be asked to state or recite the requested routing information. As such, the requested information is directed into the ASR unit 208 by the external source using the spoken destination address, or the turn-by-turn routing directions to the destination, or the latitude and longitude coordinates of the destination, at step 406. Statements spoken by the external source may include words and phrases that determine individual portions or legs of the route, such as “turn,” “right on,” “left on,” “north,” “south,” “stop,” “watch for,” “street,” “number,” and “building,” among others.

At step 408, the user checks whether the ASR unit 208 correctly recognized the uttered information. This may be accomplished by either providing a visual feedback of the text recognized by the ASR or with an audio playback of the recognized segments as generated by the TTS unit 303. Errors may be corrected or rectified by asking the external source to repeat the uttered words or phrases, at step 410. Alternatively, the user may rephrase the provided information by repeating in his own words what was uttered by the external source, at step 414, to clarify the entered information that the user wishes to store for later retrieval. The user may re-phrase the provided information for simplification purposes. Once satisfied, the user may finalize the information generated by the ASR unit 208 and selectively store the information in textual information for future playback, at step 416. Alternatively, the user may input the textual routing information into the navigational system 222. When prompted, the navigational system 222 may display a map responsive to the text representation of the received destination information.

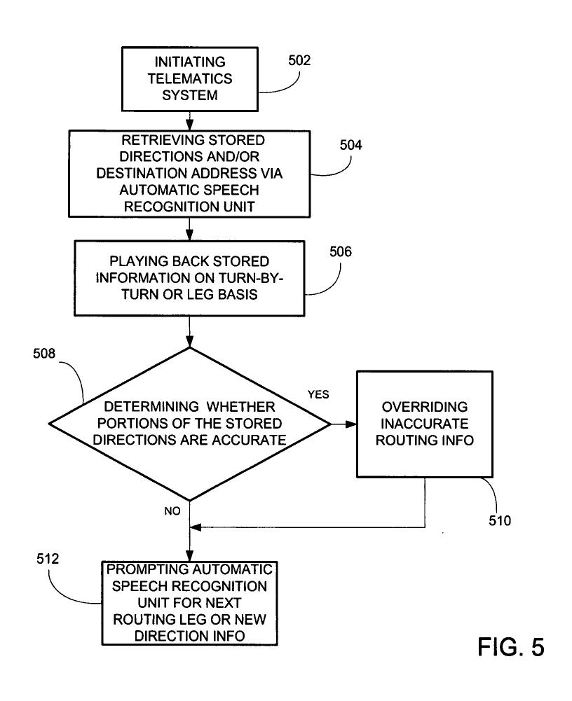

Turning now to FIG. 5, a flow chart shows an example method for playing back directional information stored in the telematics communication unit. In one embodiment, at step 502, the user initiates the telematics communication unit 114 for playback of stored destination information. The user then prompts the ASR unit 208, through a mechanical switch or a voice command, to retrieve a predetermined stored routing information, at step 504. The retrieved text segment may be processed through the TTS unit, which will render the information to the user through the vehicle audio speakers. The turn-by-turn play back may be performed by giving each leg of the route or journey at it occurs. After a voiced portion of the route, turn, or leg of the route, has been reached, the user prompts the ASR unit 208 to move on to the next leg of the route, by uttering the appropriate keyword, at step 512. The ASR unit 208 may sort the individual legs of the route by recognizing keywords or phrases, such as “left on,” “right on,” “pause,” among others. Alternatively, the ASR unit 208 may be prompted to repeat the entire route, or only what has already been given. Via the ASR unit 208 and the navigational system 222, visual and voice prompts may guide or route the user easily from origin to the destination point. Moreover, a variety of settings in the navigational system 222 may enable the user to create optimal routes.

Via the controller 204 and the ASR unit 208, the telematics communication unit 114 may also provide command-and-control capabilities. The user may also access and operate phone functions, including storing phone numbers via name association and dialing, or take notes through a built-in memo and transcription function. A similar audio monitoring may be used to store the name and phone number into a contact list provided by the external source. The audio stream from the external source is processed by the ASR unit 208 upon recognition of a keyword such as “store name” or “store number.” Audio feedback is provided as previously described to allow the user to correct the information, should an error have occurred.

The proposed method of applying ASR and TTS technology through a voice activated user interface for receiving speech data from an external user or information source, processing the received information and storing it for future information retrieval provides users with and easy access to key information without the need to directly interact with a device (such as an audio recorder, laptop, PDA, or even pen and paper). The proposed method removes a need to manually input destination address since the external caller or information source may be able to directly input the data or information by voice and even confirm the provided information, thereby reducing a potential of entering a wrong destination address.

It is therefore intended that the foregoing detailed description be regarded as illustrative rather than limiting, and that it be understood that it is the following claims, including all equivalents, that are intended to define the spirit and scope of this invention.

1. A method of providing automatic speech recognition (ASR) methodology for monitoring and playback through a communication device comprising:
establishing a voice communication link between an external source and a user;
receiving information from the external source;
processing the received information using an ASR unit;
selectively storing the received information; and
playing back the processed ASR results information.

2. The method of claim 1 wherein processing comprises automatically activating the ASR unit by the established voice communication.

3. The method of claim 2 wherein processing further comprises activating the ASR unit by uttering predetermined keywords.

4. The method of claim 1 wherein processing comprises activating the ASR unit via an operation of a corresponding mechanical switch.

5. The method of claim 1 wherein processing comprises halting the ASR unit by an utterance of corresponding predetermined keywords.

6. The method of claim 1 wherein the processing is halted via operation of a corresponding mechanical switch.

7. The method of claim 1 further comprising overriding a portion of the ASR results during the voice communication.

8. The method of claim 7 wherein overriding of the portion of the ASR results comprise repeating, by the user, exactly the received information.

9. The method of claim 7 wherein the overriding of the portion of the ASR results comprise repeating, by the user, the received information in his own words.

10. The method of claim 1 wherein receiving comprises receiving a destination address for a navigation system.

11. The method of claim 1 wherein receiving comprises at least one of receiving turn-by-turn directions to a destination for a navigation system, receiving a voice message, storing an address of a location, storing phone numbers via a name association, or taking notes through a memo and transcription function.

12. The method of claim 1 wherein selectively storing the received information comprises storing the received information in textual information or at selected conversation time points.

13. A method of providing Automatic Speech Recognition (ASR) methodology for monitoring and playback through a communication device comprising:
establishing a voice communication link between an external source and a user;
receiving destination information from the external source;
processing the received information using an ASR unit;
converting the processed information into a text representation; and
providing the text representation.

14. The method of claim 13 wherein providing the text representation comprises displaying a location of the received destination information on a corresponding portion of a stored map on a navigational system, where the navigational system comprises a display window or screen.

15. The method of claim 14 wherein displaying a location comprises the navigational system displaying a map route connecting the user location and the received destination information.

16. A system for providing Automatic Speech Recognition (ASR) methodology for monitoring and playback through a communication device comprising:
an ASR unit that processes information received from an external source;
a storage that selectively stores the processed information in a textual form; and
means for determining the accuracy of the received information.

17. The system of claim 16 wherein the ASR unit is coupled to the communication device.

18. The system of claim 16 wherein the ASR unit is integral to the communication device.

19. The system of claim 16 wherein the playback is provided on a turn-by-turn approach of directions via the text-to-speech unit.

20. The system of claim 19 wherein the playback provides a remaining portion of the directions via the text-to-speech unit.
